(19) United States
(12) Patent Application Publication
(10) Pub. No.: US 2016/0202793 A1
(43) Pub. Date: Jul. 14, 2016

(54) TOUCH SCREEN PANEL AND DISPLAY DEVICE INCLUDING THE SAME

(71) Applicant: Samsung Display Co., Ltd., Yongin-City (KR)

(72) Inventors: Yeon Tae KIM, Yongin-City (KR); Young Soo NO, Yongin-City (KR); Hwan Hee JEONG, Yongin-City (KR); In Young HAN, Yongin-City (KR)

(21) Appl. No.: 14/872,853

(22) Filed: Oct. 1, 2015

(30) Foreign Application Priority Data
Jan. 9, 2015 (KR) 10-2015-0003515

(51) Int. Cl. G06F 3/044

(52) U.S. Cl. CPC G06F 3/044

(57) ABSTRACT

The touch screen panel includes: a base substrate; and a plurality of sensing cells disposed on the base substrate. The sensing cells may include a plurality of randomly disposed conductive patterns.

### CROSS-REFERENCE TO RELATED APPLICATION

This application claims priority to and the benefit of Korean Patent Application No. 10-2015-0003515, filed on Jan. 9, 2015, in the Korean Intellectual Property Office, the entire contents of which are incorporated herein by reference in their entirety.

### BACKGROUND

1. Field

The present disclosure relates to a touch screen panel, and a display device including the same.

2. Description of the Related Art

A touch screen panel is an input device allowing a user to input a command of the user by selecting contents shown on a screen of a display device by touching or almost touching (e.g., hovering over) an area of the display device using a hand of a person or an object.

The touch screen panel generally recognizes a touch according to an electric contact or a change in capacitance by using a transparent conductive layer, such as an indium tin oxide (ITO) film.

Recently, a metal mesh having high electric conductivity replacing the transparent conductive layer is applied in the touch screen panel.

However, because a pattern of the metal mesh has a regular line arrangement form, the pattern of the metal mesh may cross a pixel pattern, an electrode pattern, or a pattern form of another optical film of the display panel and thereby cause optical interference, such as a moire effect.

### SUMMARY

The present system and method have been made in an effort to solve the above-described problems associated with the prior art, and provides a touch screen panel with improved display quality and a display device including the touch screen panel.

An exemplary embodiment of the present system and method provides a touch screen panel, including: a base substrate; and a plurality of sensing cells disposed on the base substrate. The sensing cells may include a plurality of randomly disposed conductive patterns.

Some of the conductive patterns may have closed curve shapes, and two adjacent conductive patterns may cross each other to form two or more crossing points.

One of the two conductive patterns may include an opening that blocks a crossing segment from meeting a crossing point.

The conductive patterns may have a shape selected from a group consisting of a circle, a polygonal shape, and an irregular closed curve.

The conductive patterns may include one or more of silver (Ag), aluminum (Al), copper (Cu), chromium (Cr), nickel (Ni), and gold (Au).

The conductive patterns may have different sizes.

Another exemplary embodiment of the present system and method provides a display device, including: a display panel configured to display an image; and a touch screen panel disposed in a direction in which an image is emitted in the display panel.

According to the exemplary embodiments of the present system and method, in the aforementioned touch screen panel, the sensing cells may include the plurality of randomly disposed conductive patterns, and the conductive patterns and the pixels of the display panel may irregularly cross, thereby suppressing the moire effect of the display device. Further, the number of segments crossing at the crossing point CP may be decreased, thereby suppressing the sparkling effect of the display device. Accordingly, it is possible to improve the display quality of a display device including the touch screen panel.

### BRIEF DESCRIPTION OF THE DRAWINGS

Example embodiments are described more fully hereinafter with reference to the accompanying drawings. However, the present system and method may be embodied in different forms and are not limited to the embodiments set forth herein. Rather, these embodiments are provided so that this disclosure will be thorough and complete, and will fully convey the scope of the example embodiments to those skilled in the art.

In the drawings, the dimensions of the figures may be exaggerated for clarity of illustration. When an element is referred to as being “between” two elements, it may be the only element between the two elements, or one or more intervening elements may also be present. Like reference numerals refer to like elements throughout.

FIG. 1 is an exploded perspective view illustrating a display device according to an exemplary embodiment of the present system and method.

FIG. 2 is a top plan view schematically illustrating the touch screen panel illustrated in FIG. 1.

FIG. 3 is a top plan view of a disposition of conductive patterns according to an exemplary embodiment of the present system and method.

FIG. 4 is an enlarged view of region A of FIG. 3.

FIGS. 5 and 6 are top plan views of a disposition of conductive patterns according to other exemplary embodiments of the present system and method.

FIGS. 7, 8, 9, and 10 are top plan views associated with a method of randomly disposing the conductive patterns according to an embodiment of the present system and method.

### DETAILED DESCRIPTION

Although specific embodiments are illustrated in the drawings and described below, the present system and method may be variously modified and have various forms. That is, the present system and method are not limited to the specific embodiments disclosed herein but include all changes, equivalents, or alternatives that are included in the spirit and technical scope of the present system and method.

In the description of respective drawings, similar reference numerals designate similar elements. In the accompanying drawings, the sizes of structures are illustrated to be enlarged compared to actual sizes for clarity of view. The terms “first”, “second”, and the like may be used to discriminate one constituent element from another constituent element. The constituent elements, however, are not limited by these terms. For example, a first element may be referred to as a second element, and vice versa, without departing from the scope of the present disclosure. Singular expressions used herein include plurals expressions unless the context clearly indicates otherwise.

In the present application, the terms “including” and “having” are intended to designate the existence of characteristics, numbers, steps, operations, constituent elements, and components described in the specification or a combination thereof, and do not exclude the existence or addition of one or more other specific characteristics, numbers, steps, operations, constituent elements, and components, or a combination thereof When an element, such as a layer, film, region, or substrate, is referred to as being “on” another element, it may be directly on the other element, or intervening elements may also be present. Likewise, when an element, such as a layer, film, region, or substrate, is referred to as being “beneath” another element, it may be directly beneath the other element, or intervening elements may also be present.

Hereinafter, an exemplary embodiment of the present system and method is described in detail with reference to the accompanying drawings.

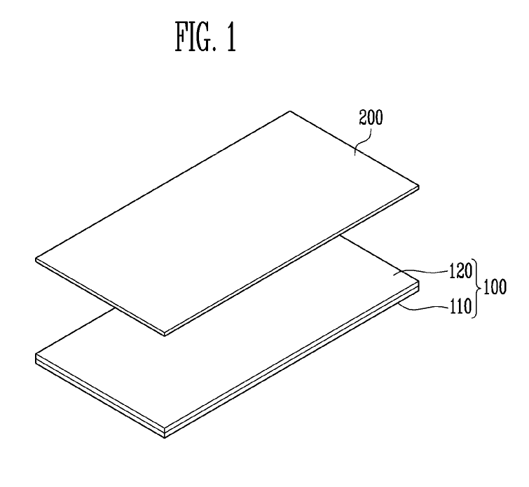

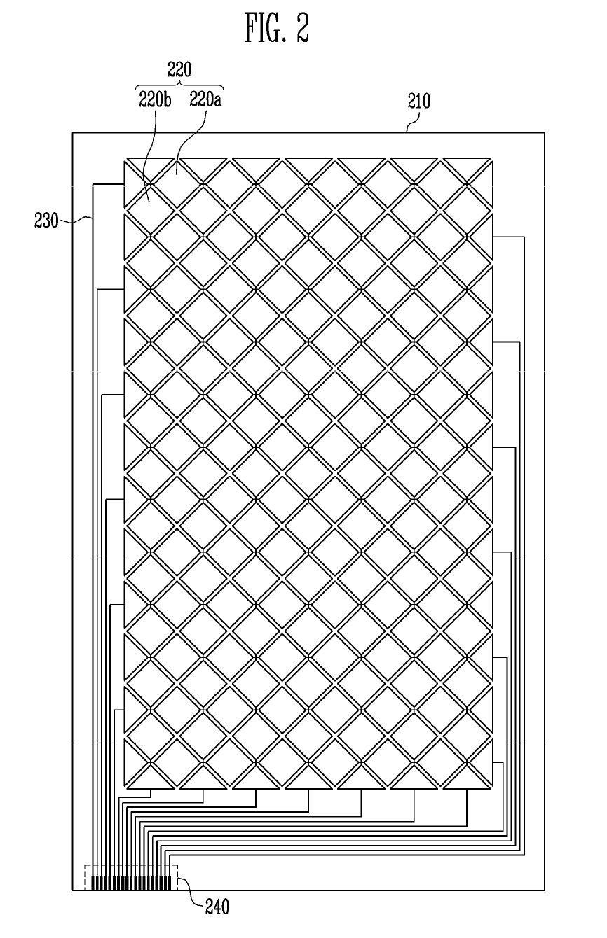

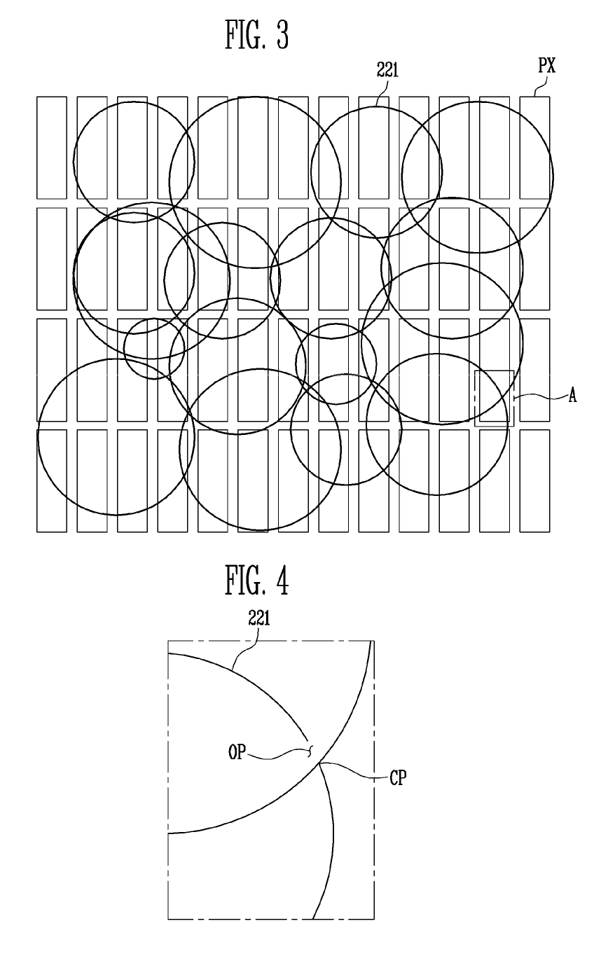

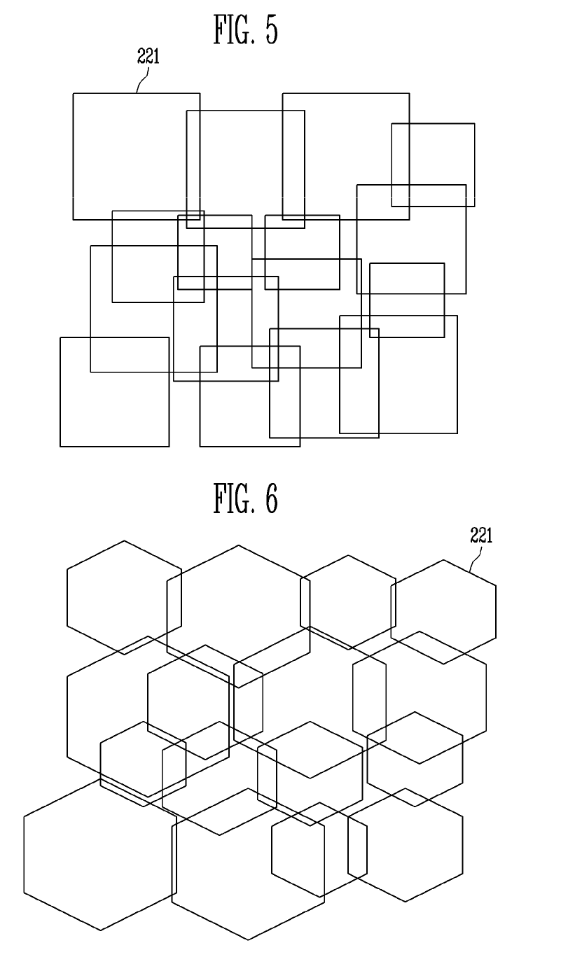

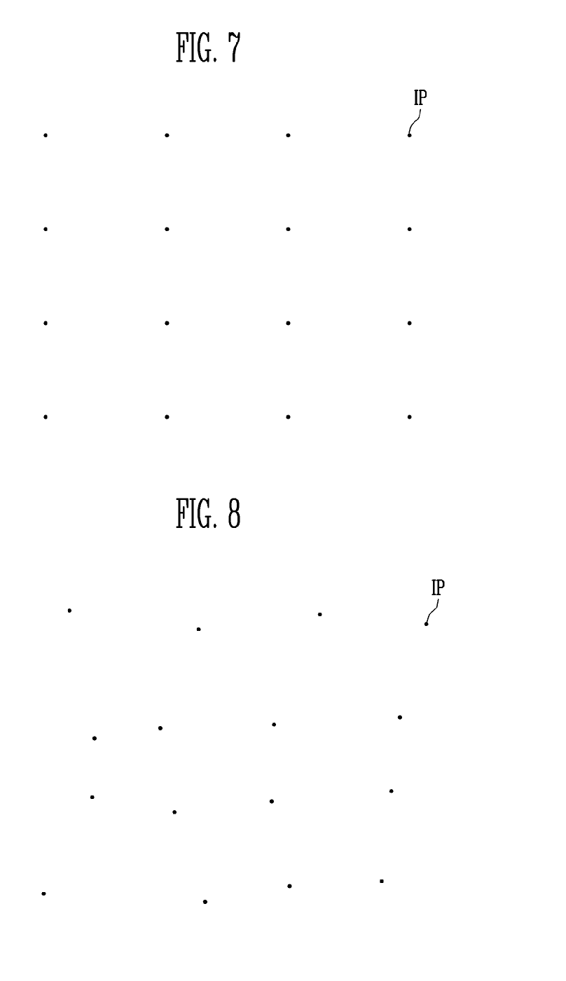

FIG. 1 is an exploded perspective view illustrating a display device according to an exemplary embodiment of the present system and method. FIG. 2 is a top plan view schematically illustrating the touch screen panel illustrated in FIG. 1. FIG. 3 is a top plan view of a disposition of conductive patterns according to an exemplary embodiment of the present system and method. FIG. 4 is an enlarged view of region A of FIG. 3. FIGS. 5 and 6 are top plan views of a disposition of conductive patterns according to other exemplary embodiments of the present system and method.

Referring to FIGS. 1 to 6, the display device may include a display panel 100 and a touch screen panel 200.

The display panel 100 may display an image. The display panel 100 is not particularly limited. For example, a self-emitting display panel, such as an Organic Light Emitting Display (OLED) panel, may be used as the display panel 100. Further, a non-emissive display panel, such as a Liquid Crystal Display (LCD) panel, an Electro-Phoretic Display (EPD) panel, and an Electro-Wetting Display (EWD) panel, may be used as the display panel 100. When the non-emissive display panel is used as the display panel 100 of a display device, the display device may also include a backlight unit for supplying light to the display panel 100. The present exemplary embodiments are described for the case in which the OLED panel is used as the display panel 100.

The display panel 100 may include a plurality of pixels PX. Each pixel PX may be one of a red pixel, a green pixel, a blue pixel, and a white pixel but is not limited thereto. For example, the pixel may also be one of a magenta pixel, a cyan pixel, and a yellow pixel.

Further, the display panel 100 may include a first substrate 110 on which organic light emitting devices are disposed and a second substrate 120 facing the first substrate 110.

The first substrate 110 may include a thin film transistor substrate (not illustrated) disposed at one of its sides. The thin film transistor substrate may include one or more thin film transistors disposed on an insulating substrate and connected to the organic light emitting devices. Further, the first substrate 110 may include a driver (not illustrated) capable of driving the organic light emitting device. Here, the driver may be a Chip On Glass (COG) type driving device.

The organic light emitting devices are disposed on the thin film transistor substrate. Further, the organic light emitting device may include a first electrode connected to the thin film transistor, an organic layer disposed on the first electrode, and a second electrode disposed on the organic layer. One of the first electrode and the second electrode may be an anode electrode and the other may be a cathode electrode. At least one of the first electrode and the second electrode may be transparent.

For example, the first electrode may be a conductive layer and include one or more transparent conductive oxides selected from among an indium tin oxide (ITO), an indium zinc oxide (IZO), an aluminum zinc oxide (AZO), a gallium doped zinc oxide (GZO), a zinc tin oxide (ZTO), a Gallium tin oxide (GTO), and a fluorine doped tin oxide (FTO). The second electrode may reflect light and include one or more of molybdenum (Mo), molybdenum tungsten (MoW), chromium (Cr), aluminum (Al), aluminum neodymium (A1Nd), and an Al alloy having a lower work function than that of the first electrode.

The organic layer may include an emitting layer EML and generally have a multilayer thin film structure. For example, the organic layer may include a hole injection layer HIL for injecting holes, a hole transport layer HTL having an excellent hole transporting property, an electron blocking layer EBL for suppressing the movement of electrons that fail to be combined in the emitting layer EML so as to increase the opportunity for the holes and the electrons to be re-combined, the emitting layer EML for emitting light through the re-combination of the injected electrons and holes, a hole blocking layer HBL for suppressing the movement of holes that fail to be combined in the emitting layer EML, an electron transport layer ETL for smoothly transporting electrons to the emitting layer EML, and an electron injection layer (EIL) for injecting electrons.

The color of light generated in the emitting layer may be one of red, green, blue, and white but is not limited thereto. For example, the color of light generated in the emitting layer may also be one of magenta, cyan, and yellow.

The second substrate 120 may be bonded to the first substrate 110 through an encapsulant, such as a sealant to isolate the organic light emitting devices from an external environment. For example, the second substrate 120 may be a transparent insulating substrate. In some cases in which the organic light emitting devices are encapsulated by a transparent insulating layer and the like, the second substrate 120 may be omitted.

The touch screen panel 200 is disposed in a direction in which an image of the display panel 100 is emitted. For example, the touch screen panel 200 may be disposed on an external surface of the second substrate 120 to receive a touch input of a user.

The touch screen panel 200 may include a base substrate 210 made of a transparent material, sensing patterns 220 disposed on the base substrate 210, and sensing lines 230 for connecting the sensing patterns 220 to an external driving circuit (not illustrated) through a pad part 240.

The sensing patterns 220 may include first sensing cells 220a formed to be connected to each other for each row in a row direction and second sensing cells 220b formed to be connected to each other for each column in a column direction. The first sensing cells 220a and the second sensing cells 220b may be alternately disposed so as not to overlap each other.

The first sensing cells 220a and the second sensing cells 220b may include a plurality of conductive patterns 221 that are randomly disposed. The conductive patterns 221 may have different sizes. That is, the conductive patterns 221 may also have random sizes. Further, the conductive patterns 221 may include one or more materials selected from silver (Ag), aluminum (Al), copper (Cu), chromium (Cr), nickel (Ni), and gold (Au).

The random disposition of the conductive patterns 221 may mean that the conductive patterns 221 are disposed without a specific rule or period. Accordingly, the conductive patterns 221 and the pixels PX may irregularly cross. As a result, the moire effect caused by the regular crossing of the conductive patterns 221 and the pixels PX may be prevented.

Further, the conductive patterns 221 may have a closed curve formed of one segment or a substantially closed curve that is disconnected at or near a crossing point CP (more details below) but maintains the overall shape of a closed curve. Here, the conductive patterns 221 may have the overall shape of a circle, a polygon, or an irregular closed curve. For example, the conductive patterns 221 may have a circular shape as illustrated in FIG. 3. Further, the conductive patterns 221 may have a quadrangular shape or a hexagonal shape as illustrated in FIGS. 5 and 6.

The segments of two adjacent conductive patterns 221 may cross each other to form two or more crossing points CP. Accordingly, the two adjacent conductive patterns 221 may be electrically connected.

At the crossing point CP, one of the crossing conductive patterns 221 may be disconnected by an opening OP. That is, the opening OP may block one of four segments from crossing at the crossing point CP. Accordingly, as illustrated in FIG. 4, the number of segments crossing at the crossing point CP is three.

When the number of crossing segments at a crossing point CP is large, visibility of the display device may deteriorate. The amount of visibility deterioration may correspond to a ratio of the light emitted from a pixel corresponding to the crossing point CP that is blocked by the conductive patterns 221. Particularly, a decrease in the light quantity emitted by a specific pixel may cause a sparkling effect. That is, the sparkling effect is generated when the light quantity irradiated from the pixel positioned at the crossing point CP to the outside is relatively decreased compared to the light quantity emitted from neighboring pixels to the outside. Accordingly, when the number of segments crossing at the crossing point CP is decreased by the opening OP, visibility of the display device is improved.

The sensing lines 230 may be electrically connected with the first sensing cells 220a and the second sensing cells 220b in a row line unit and a column line unit, respectively. Accordingly, the sensing lines 230 may electrically connect the first sensing cells 220a and the second sensing cells 220b and an external driving circuit (not illustrated), such as a position detection circuit, through the pad part 240.

The sensing lines 230 may be disposed at an outer portion of an active area where an image is displayed. The sensing lines 230 may include one of the low resistance materials, for example, molybdenum (Mo), silver (Ag), titanium (Ti), copper (Cu), aluminum (Al), and molybdenum/aluminum/molybdenum (Mo/Al/Mo). Further, the sensing lines 230 may also include the same material as that of the sensing patterns 220.

When a contact object, such as a hand of a person or a stylus pen, touches the capacitive touch panel, the touch screen panel 200 transmits a change in capacitance according to a contact position from the sensing patterns 220 to the driving circuit (not illustrated) through the sensing lines 230 and the pad part 240. Then, the change in the capacitance is converted into an electric signal by an X and Y input processing circuit (not illustrated) and the like, so that the contact position may be recognized.

As described above, the conductive patterns 221 and the pixels PX of the display panel 100 may irregularly cross, thereby suppressing the moire effect of the display device. Further, the number of segments crossing at the crossing point CP may be decreased, thereby suppressing the sparkling effect of the display device. Accordingly, it is possible to improve the display quality of the display device.

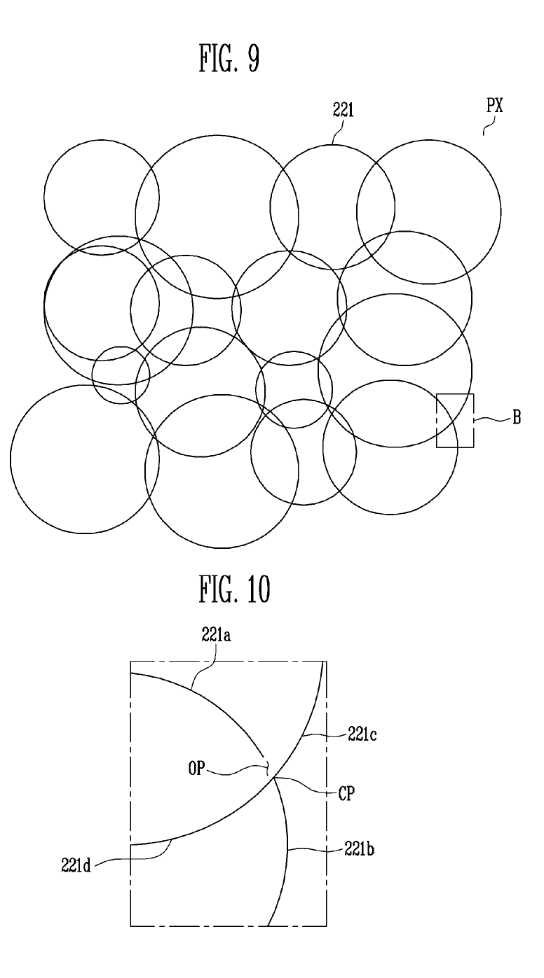

Next, a random disposition method of the conductive patterns 221 is described with reference to FIGS. 7 to 10.

FIGS. 7 to 10 are top plan views associated with a method of randomly disposing the conductive patterns according to an exemplary embodiment of the present system and method.

Referring to FIG. 7, virtual initial points IP are generated in a two-dimensional (2D) space. Here, the initial points IP may be regularly disposed in the vertical and horizontal directions. For example, the initial points IP may be virtual lattice points drawn on a surface of the base substrate 210.

Referring to FIG. 8, each of the initial points IP is moved by a predetermined distance in the horizontal direction. Here, the horizontal movement distances of the respective initial points IP may be different from each other.

Then, each of the initial points IP is moved by a predetermined distance in the vertical direction. Here, the vertical movement distances of the respective initial points IP may be different from each other. Accordingly, the disposition of the initial points IP does not have a period or a rule in all of the horizontal direction and the vertical direction.

In the present exemplary embodiment, the initial points IP are moved in the horizontal direction and then moved in the vertical direction for disposition, but the present system and method are not limited thereto. For example, the initial points IP may be moved in the vertical direction, and then moved in the horizontal direction for disposition.

Referring to FIG. 9, the conductive patterns 221 shaped like a closed curve are formed based on the initial points IP, respectively. For example, the conductive patterns 221 may be formed by depositing a metal layer including one or more materials selected from silver (Ag), aluminum (Al), copper (Cu), chromium (Cr), nickel (Ni), and gold (Au) on the base substrate 210 and patterning the metal layer.

The conductive patterns 221 may have different sizes. That is, the conductive patterns 221 may also have random sizes.

Further, the conductive patterns 221 may have an overall shape of a circle, a polygon, or an irregular closed curve. For example, the conductive patterns 221 may have a circular shape. The two adjacent conductive patterns 221 may cross each other to form two or more crossing points CP.

Referring to FIG. 10, the total number of segments crossing at the crossing points CP formed by crossing of the adjacent conductive patterns 221 may be four. When the number of crossing segments meeting at the crossing points CP is large, the image quality of the display device may deteriorate. Accordingly, one of the segments meeting at the crossing points CP may be removed.

For example, the number of conductive patterns 221 forming one crossing point CP may be two. One of the conductive patterns 221 may be divided into a first segment 221a and a second segment 221b, and the other may be divided into a third segment 221c and a fourth segment 221d based on the crossing point CP.

The opening OP is formed by removing a region from where one of the first to fourth segments 221a, 221b, 221c, and 221d meet the crossing point CP (for example, the first segment 221a). Accordingly, the number of segments that meet at the crossing point CP is three. Despite the opening OP, the two adjacent conductive patterns 221 remain electrically connected to each other.

The opening OP may be formed by using etching or laser cutting.

Through the aforementioned process, the conductive patterns 221 may be randomly disposed. Accordingly, the conductive patterns 221 and the pixels PX of the display panel 100 may irregularly cross, thereby suppressing the moire effect of the display device. Further, the number of segments crossing at the crossing point CP may be decreased, thereby suppressing the sparkling effect of the display device.

Accordingly, it is possible to improve the display quality of the display device. Although specific terms are employed to describe the example embodiments disclosed herein, these terms are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, those of ordinary skill in the art would understand that various changes in form and details may be made without departing from the spirit and scope of the present system and method as set forth in the following claims.

What is claimed is:

1. A touch screen panel, comprising:
a base substrate; and
a plurality of sensing cells disposed on the base substrate,
wherein the sensing cells include a plurality of randomly disposed conductive patterns.

2. The touch screen panel of claim 1, wherein some of the conductive patterns have closed curve shapes.

3. The touch screen panel of claim 2, wherein two adjacent conductive patterns cross each other to form two or more crossing points.

4. The touch screen panel of claim 3, wherein one of the two conductive patterns includes an opening that blocks a crossing segment from meeting a crossing point.

5. The touch screen panel of claim 2, wherein the conductive patterns have a shape selected from a group consisting of a circle, a polygonal shape, and an irregular closed curve.

6. The touch screen panel of claim 2, wherein the conductive patterns include at least one of silver (Ag), aluminum (Al), copper (Cu), chromium (Cr), nickel (Ni), and gold (Au).

7. The touch screen panel of claim 2, wherein the conductive patterns have different sizes.

8. A display device, comprising:
a display panel configured to display an image; and
a touch screen panel disposed in a direction in which an image is emitted in the display panel,
wherein the touch screen panel includes:
a base substrate; and
a plurality of sensing cells disposed on the base substrate, and
the sensing cells include a plurality of randomly disposed conductive patterns.

9. The display device of claim 8, wherein some of the conductive patterns have closed curve shapes.

10. The display device of claim 9, wherein two adjacent conductive patterns cross each other to form two or more crossing points.

11. The display device of claim 10, wherein one of the two conductive patterns includes an opening that blocks a crossing segment from meeting a crossing point.

12. The display device of claim 9, wherein the conductive patterns have a shape selected from a group consisting of a circle, a polygonal shape, and an irregular closed curve.

13. The display device of claim 9, wherein the conductive patterns include at least one of silver (Ag), aluminum (Al), copper (Cu), chromium (Cr), nickel (Ni), and gold (Au).

14. The display device of claim 9, wherein the conductive patterns have different sizes.
